(19) United States
(12) Patent Application Publication
(10) Pub. No.: US 2026/0211388 A1
(43) Pub. Date: Jul. 23, 2026

(54) FIELD DEVICE FOR AN INDUSTRIAL PLANT

(71) Applicant: Murrelektronik GmbH, Oppenweiler (DE)

(72) Inventors: Rudolf LANG, Oppenweiler (DE); Steffen RIEDEL, Oppenweiler (DE); Timo SETZER, Oppenweiler (DE)

(21) Appl. No.: 19/453,181

(22) Filed: Jan. 20, 2026

(30) Foreign Application Priority Data
Jan. 20, 2025 (DE) 10 2025 101 807.3

(51) Int. Cl. G05B 15/02; G06F 3/044

(52) U.S. Cl. CPC G05B 15/02; G06F 3/044; G06F 2203/04108

(57) ABSTRACT

A field device for an industrial plant including at least one capacitive operating element by which an operating mode of the field device can be set, and a processor which is coupled to the at least one capacitive operating element. The processor is set up to implement an operation of the capacitive operating element only if a release based on an actuation pattern or an external release signal has been effected. Furthermore, a method of setting an operating mode of a field device is described.

### FIELD OF THE DISCLOSURE

Embodiments of the present disclosure relate to a field device for an industrial plant and to a method of setting an operating mode of a field device.

### BACKGROUND

A multitude of electronic devices, such as sensors or actuators, which are driven via field devices, are often installed in modern machines and/or plants.

Many classic field devices have operating elements for setting parameters, for example switches or buttons. To realize such operating elements, openings are typically formed in the housing of the field device, which are then at least partially closed with the respective operating element and specific seals. To prevent foreign objects or liquids from entering the interior of the housing through the openings, a seal is typically provided in the area of the respective operating element.

Installation and sealing are usually technically complex and expensive. In addition, the seals may fail due to wear, aging, or improper handling, which in turn results in that the electronic components arranged inside the housing are no longer adequately protected from environmental influences. Furthermore, defects in the respective operating elements and/or improper handling may lead to operating errors.

The object is therefore to overcome the disadvantages known from the prior art and to provide an easily operable and robust field device which can also be manufactured in a cost-effective manner.

### SUMMARY

The object is achieved by a field device for an industrial plant, comprising at least one capacitive operating element by means of which an operating mode of the field device can be set. The field device has a processor which is coupled to the at least one capacitive operating element and is set up to implement an operation of the capacitive operating element only if a release based on an actuation pattern or an external release signal has been effected.

The basic idea is to make operating mode settings on the field device using the capacitive operating element. It can be operated through the housing wall of the field device, for example by a user touching the housing wall. Openings in the housing, which reduce the protection of the internal electronics, may thus be avoided. It is therefore not necessary, either, to provide seals, as a result of which the field devices can be manufactured cost-effectively. At the same time, it is ensured that there is no incorrect operation or unwanted access to the field device by only implementing the operation if a corresponding release has been effected.

In one variant, all operating elements of the field device are configured as capacitive operating elements and arranged within the housing such that they can be manually actuated by a user from the outside through a wall of the housing. In other words, the field device does not have any (mechanical) operating elements which are connected to the internal electronics via housing openings, such as switches or buttons, or which require the housing to be opened to be operated, for example via a service flap.

It is also conceivable that the field device has only a single capacitive operating element, which can be used in particular to perform a factory reset, i.e., to return the field device to an initial operating mode. Incorrect settings on the field device can thus be corrected easily and reliably.

In one variant embodiment, the at least one capacitive operating element comprises two capacitive areas arranged on different sides of the field device. In particular, the two capacitive areas are arranged on opposite sides of the field device. The fact that two capacitive areas which are spatially separated from each other are used to set the operating mode may reduce the risk of unintentional inputs due to accidental contact with the field device.

For example, the field device has a connection side, a first longitudinal side, a second longitudinal side, a first end side, and a second end side, wherein one of the two capacitive areas is located on the first longitudinal side of the field device and the other of the two capacitive areas is located on the second longitudinal side of the field device.

It became apparent that this arrangement enables ergonomically a particularly easy operation of the field device. For example, a user can grasp the field device with one hand and thus reach and operate the two capacitive areas located on the longitudinal sides simultaneously with different fingers of the hand, in particular the thumb and another finger such as the index finger or middle finger.

In this context, it is also conceivable that the field device has a maximum width which allows it to be grasped with one hand. For example, the maximum width and/or the maximum distance between the two capacitive areas is at most 15 cm, preferably at most 10 cm, and particularly preferably at most 7 cm.

In principle, simultaneous contact with the first capacitive area and the second capacitive area may constitute an actuation pattern. It is also conceivable that simultaneous contact leads in both release and operation. In other words, both input and release can be effected by the user at the same time. This enables very simple and time-efficient operation.

However, a different temporal sequence, i.e., other than simultaneous, may also be provided as an actuation pattern, e.g., touching the first capacitive area for a defined duration, e.g., two seconds, which would only then result in a touch of the second capacitive area being detected or released.

In principle, a temporally distributed input via at least one capacitive area of the operating element or via a capacitive release element comprised by the field device may thus be provided as actuation pattern. For example, a user can input the actuation pattern required for release by touching one or more capacitive areas of the actuation element or (if available) the capacitive release element for a certain period of time and/or repeatedly.

According to one aspect, at least two taps on at least one capacitive area of the actuating element or (if available) the capacitive release element is provided as actuation pattern.

In a further variant, it is provided that the field device has an output element for outputting a signal which specifies the actuation pattern to the user. For example, the output element is an optical signal transmitter which is configured to output a light signal at the location where the capacitive operating element is arranged. In particular, the optical signal transmitter may comprise one or more light sources arranged within the housing of the field device, which can emit light such that it can pass to the outside through the housing wall in the area of the capacitive operating element and be perceived by a user. For this purpose, the housing may be configured to be at least partially transparent. Openings in the housing are therefore not necessary for outputting the signal.

In a design with two capacitive areas arranged on opposite sides of the field device, it is of course also possible to provide a plurality of light sources and/or light guides to enable signal outputs at the respective capacitive areas, i.e., on the opposite sides of the field device.

For example, the signal outputs input specifications for a user. Specifically, the optical signal transmitter can be used to generate a flashing pattern, for example, which specifies to the user the time intervals at which the user must touch a specific capacitive area to make and/or release an input. In this case, the at least one capacitive operating element is operated according to the actuation pattern output by the output element. This simplifies operation and reduces the risk of incorrect entries.

Alternatively or in addition to a release by the user himself/herself, it is also possible that the release is effected by an external release signal. The external release signal may be, for example, a radio signal or a signal received via a supply line of the field device. It is also conceivable that the external release signal is an electrical signal by means of which the field device is activated during start-up. For example, the release signal may be specified by connecting the field device to a power supply and thus putting it into operation.

In one variant, the capacitive operating element and/or the processor is configured to allow the operating mode of the field device to be set only within a specified period of time after the field device has been put into operation. If, for example, a release signal is generated at a specific point in time by connecting the field device to a power supply, inputs can only be made from this point in time within the specified period. The specified period is, for example, a maximum of 15 minutes, preferably a maximum of 1 minute, and particularly preferably a maximum of 10 seconds. This reduces the risk of inputs by unauthorized users and thus increases overall operational safety.

To further increase operational safety, it may also be provided that the processor is set up to only allow a setting of the operating mode of the field device if a plurality of independent release conditions are met. For example, the aforementioned input within the specified time period after putting into operation of the field device may be a first release condition, and the actuation of the capacitive operating element using a specified operating pattern may be a second release condition, both of which must be fulfilled to implement the operation.

In a further variant, the field device comprises a capacitive release element which is configured to release the capacitive operating element. In other words, the setting of the operating mode on the one hand and the release on the other hand may be implemented by two separate capacitive elements. This division has proven to be technically easy to implement and particularly error-proof.

The object is further achieved by a method of setting an operating mode of a field device which has at least one capacitive operating element. The method comprises at least the steps of: detecting a release which is effected on the basis of an actuation pattern of the at least one capacitive operating element or an external release signal, and implementing an operation of the capacitive operating element only if the release has been detected beforehand.

The advantages discussed as to the field device according to the present disclosure apply equally to the method.

In a variant of the method, it is provided that the actuation pattern is a simultaneous actuation of at least two capacitive areas of the at least one capacitive operating element or an actuation of the at least one capacitive operating element in a defined time sequence. This implementation of the actuation pattern makes it possible to prevent unintentional incorrect operation or unwanted access to the field device by unauthorized users in a particularly reliable manner.

### BRIEF DESCRIPTION OF THE DRAWINGS

Further features and advantages of the present disclosure will become apparent from the following description and the drawings to which reference is made and in which:

FIG. 1 shows a schematic representation of a field device according to a first exemplary embodiment of the present disclosure;

FIG. 2 shows a schematic representation of a field device according to a second exemplary embodiment of the present disclosure; and

FIG. 3 shows a schematic representation of a field device according to a third exemplary embodiment of the present disclosure.

### DETAILED DESCRIPTION

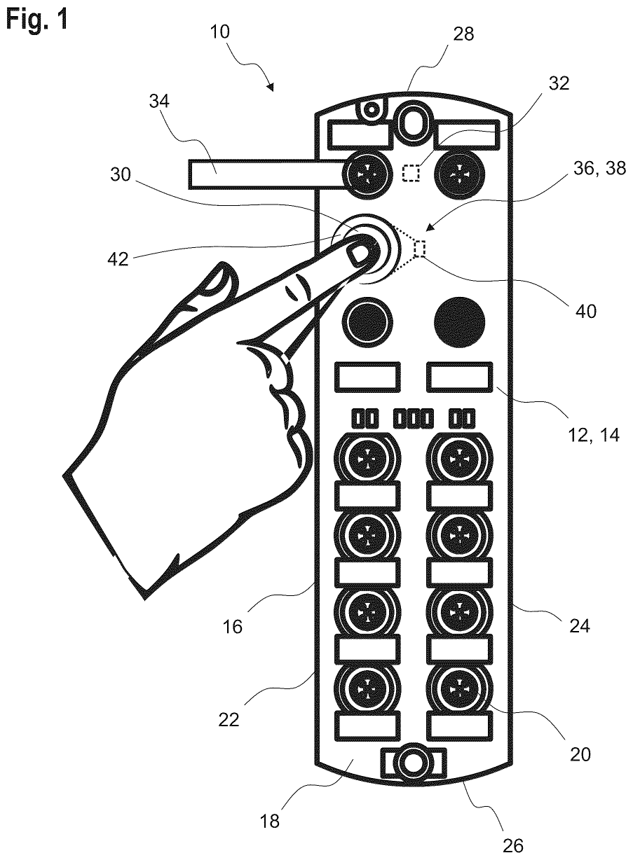

FIG. 1 shows a field device 10 according to the present disclosure in accordance with a first exemplary embodiment. The field device 10 is configured as a fieldbus module and is intended for controlling an industrial plant.

The field device 10 comprises a housing 12 having a housing wall 14. The housing 12 is formed, for example, by an integral housing part 16, which has a cavity for accommodating electronic components and is closed by a bottom of the housing.

The field device 10 has a connection side 18 having a plurality of connections 20, and a first longitudinal side 22, a second longitudinal side 24, a first end side 26, and a second end side 28.

Furthermore, the field device 10 has a capacitive operating element 30 which is arranged inside the housing 12 on the connection side 18 and by means of which an operating mode of the field device 10 can be set. For example, the capacitive operating element 30 can be used to reset the field device 10 to a factory mode and/or to select a specific operating mode with specified operating parameters.

The capacitive operating element 30 is, for example, a sensor which comprises a capacitor system or is part of a capacitor system. The sensor detects an input based on a change in an electrical capacitance of the capacitor system. For example, capacitance changes caused by a touch of the housing wall 14 and/or by a movement of a hand of a user at or near the location of the housing wall 14 where the capacitive operating element 30 is located can be detected as inputs.

In simple terms, the capacitive operating element 30 can be actuated by a user moving the hand close thereto on the housing wall 14, thus causing a change in the capacitance of the capacitor system, which can then be detected and evaluated.

Since the capacitive operating element 30 is not visible when viewing the housing 12 from the outside, a marking may optionally be provided, for example, a raised area, a recess, or a ribbing in the housing wall 14, which indicates to the user where the capacitive operating element 30 is located. Similarly, an imprint or similar may be provided on the housing 12.

Apart from the capacitive operating element 30, the field device 10 shown in FIG. 1 has no other manually actuatable operating elements. In particular, the field device 10 has no mechanical switches or buttons. The field device 10 therefore has a very robust design.

Furthermore, the field device 10 has a processor 32 which is coupled to the capacitive operating element 30 and is designed to implement operation of the capacitive operating element 30 only if (previously) a release based on an actuation pattern or an external release signal has been effected.

The external release signal is, for example, a data signal and/or a current signal which is transmitted to the field device 10 via a line 34 connected to one of the connections 20. Alternatively, it is of course also conceivable to transmit the release signal to the field device 10 by radio, WiFi, Bluetooth, ZigBee, or a comparable wireless transmission technology.

In the example embodiment shown in FIG. 1, the capacitive operating element 30 is configured to allow the operating mode of the field device 10 to be set only within a specified period of time after the field device 10 has been started up. The specified period of time is, for example, a maximum of 15 minutes, preferably a maximum of 1 minute, and particularly preferably a maximum of 10 seconds.

The start-up takes place, for example, by providing a power supply of the field device 10, in particular by connecting the field device 10 to a power source via the line 34. The current or power signal transmitted via the line 34 can therefore be a release signal.

The time limit for setting the operating mode via the capacitive operating element 30 is achieved, for example, by supplying power to the capacitive operating element 30 only within the specified period after start-up. After that, it is inactive. It can then no longer be accidentally actuated and does not consume any electrical energy.

Alternatively, actuation of the (basically still active) capacitive operating element 30 is not further processed, in particular by the processor 32.

The field device 10 shown in FIG. 1 also has an output element 36 for outputting a signal which specifies an actuation pattern to the user for actuating the capacitive operating element 30.

The output element 36 is, for example, an optical signal transmitter 38 which is configured to output the signal as a light signal at the location where the capacitive operating element 30 is arranged.

In the example shown in FIG. 1, the optical signal transmitter 38 comprises a light source 40 arranged inside the housing 12, which can emit light through an at least partially transparent area 42 of the housing 12.

In particular, during the specified period after start-up of the field device 10, the light source 40 is driven by the processor 32 so as to emit the light signal with a temporally varying actuation pattern. The actuation pattern has, for example, alternating on and off phases of variable length, which specify to the user at what time intervals and for how long the capacitive operating element 30 has to be actuated to release the setting of a desired operating mode.

Alternatively, the output element 36 may also comprise a loudspeaker and be configured to output the actuation pattern in the form of acoustic signals. A haptic output of the actuation pattern is also conceivable, for example by causing the field device 10 to vibrate via the output element 36.

The operating mode itself can be set before or after the corresponding release by further actuation of the capacitive operating element 30. Alternatively, the desired operating mode can also be set by actuating the capacitive operating element 30 with the corresponding actuation pattern itself.

It is furthermore also conceivable that the capacitive operating element 30 can be activated and/or deactivated via a data connection, in particular before the field device 10 is started up. For example, the capacitive operating element 30 can be deactivated if the field device 10 is to be used for the same application over a longer period of time and/or a change in the operating mode is undesirable for the planned use.

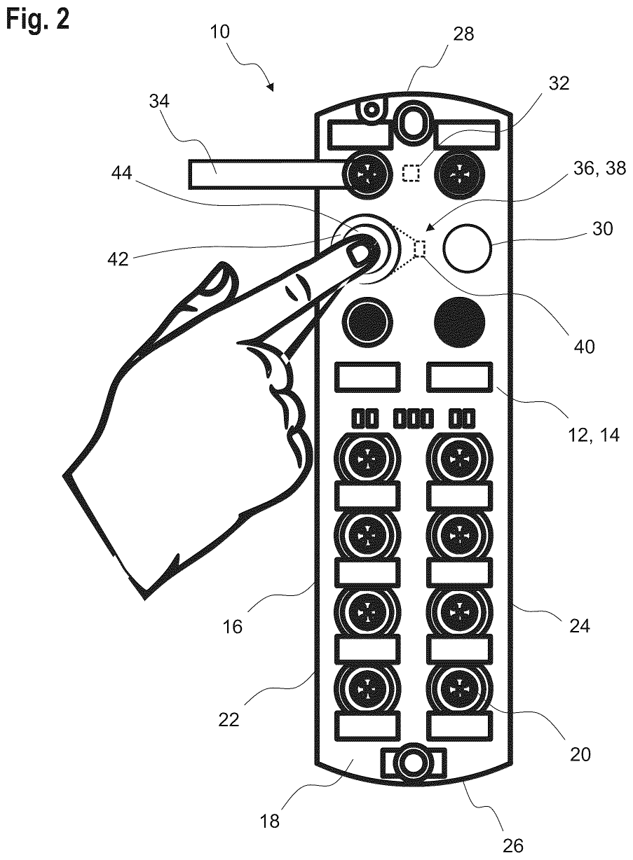

FIG. 2 shows a field device 10 according to a second exemplary embodiment of the present disclosure. This substantially corresponds to the first embodiment shown in FIG. 1, so that only the differences will be discussed below. Identical components and components with identical functions are designated by the same reference numerals.

In contrast to the first embodiment, the field device 10 shown in FIG. 2 has an additional capacitive release element 44, which is configured to release the capacitive operating element 30.

For example, the capacitive operating element 30 is only released or activated for an input if a specific actuation pattern has been previously entered by a user on the capacitive release element 44. The capacitive release element 44 and the capacitive operating element 30 can be formed by structurally identical hardware components which are driven differently by the processor 32. In simple terms, the capacitive release element 44 can also be a capacitive operating element 30.

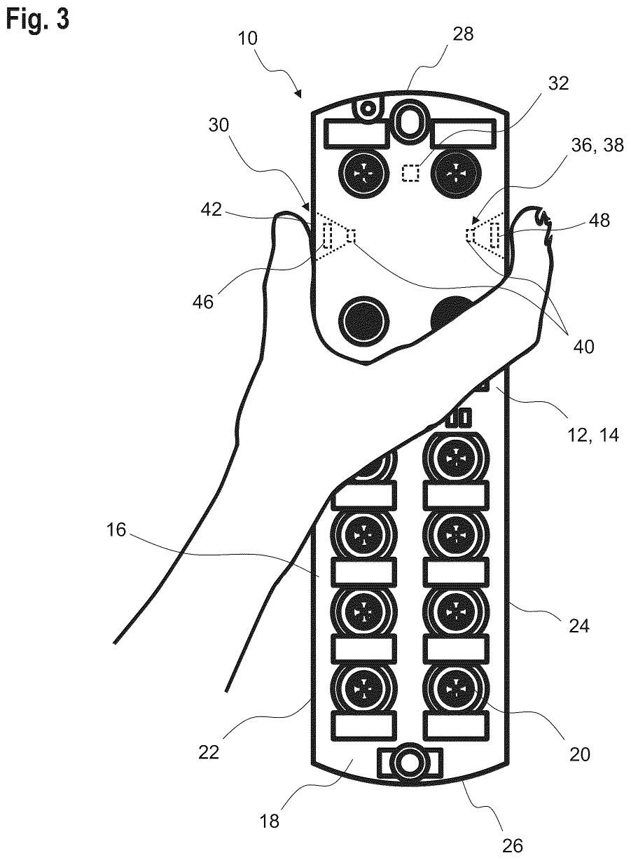

FIG. 3 shows a field device 10 according to the present disclosure in accordance with a third exemplary embodiment. This substantially corresponds to the embodiments shown in FIG. 1 and FIG. 2, so that only the differences will be discussed below. Identical components and components with identical functions are designated with the same reference numerals.

The field device 10 shown in FIG. 3 has a capacitive operating element 30, which comprises a first capacitive area 46 and a second capacitive area 48.

The first capacitive area 46 is arranged on the first longitudinal side 22. The second capacitive area 48 is arranged on the opposite second longitudinal side 24.

The first and the second capacitive area 46, 48 are arranged such that a user can grasp the field device 10 with one hand and reach and actuate both capacitive areas 46, 48 with different fingers of the hand, in particular simultaneously.

Simultaneous touching of the first and the second capacitive area 46, 48 can represent an actuation pattern by means of which operation and release also take place simultaneously.

Alternatively, analogous to the first example embodiment, an actuation pattern for actuating the two capacitive areas 46, 48 can be specified by means of an output element 3, in particular an optical signal transmitter 38, which specifies to the user at what intervals and/or for how long the respective capacitive areas 46, 48 are to be actuated to set and/or to release a desired operating mode.

The setting of the operating mode is effected in the field devices 10 shown in FIG. 1, FIG. 2, and FIG. 3 using an example embodiment of a method according to the present disclosure.

In a first step S1 of the method, the processor 32 detects a release which is effected based on an actuation pattern of the at least one capacitive operating element 30 or an external release signal.

In the field devices 10 shown in FIG. 1 and FIG. 2, the release is effected, for example, by a transmission of a data signal to the relevant field device 10 via the line 34.

Alternatively or additionally, the release can also be effected by a user actuating the at least one capacitive operating element 30 or the capacitive release element 44 in a defined time sequence. This time sequence can be fixed and/or specified to the user by the output element 36.

To ensure particularly good protection against unauthorized access, it may also be provided that the actuation pattern or the time sequence is transmitted to the field device 10 via a data connection, in particular via the line 34, and then output by the output element 36.

In the field device 10 shown in FIG. 3, the release is alternatively effected by a user simultaneously actuating the first and the second capacitive areas 46, 48. It is also conceivable that the release is effected by the user actuating the two capacitive areas 46, 48 in accordance with a specified temporal sequence.

In a second step S2 of the method, the processor 32 implements an operation of the capacitive operating element 30 and sets the desired operating mode on the field device 10. The implementation is only effected if a corresponding release has been detected in step S1 beforehand.

For example, the implementation leads to a factory reset, by means of which the field device 10 in question is reset to an original operating mode.

This allows field devices 10 that have already been used in an industrial plant to be reused, in particular by resetting them when they are started up again.

Faults can therefore also be rectified quickly and easily. At the same time, a high level of protection against unintentional incorrect inputs and inputs by unauthorized persons is provided.

List of Reference Numerals

| Reference Numeral | Designation |
|---|---|
| 10 | field device |
| 12 | housing |
| 14 | housing wall |
| 16 | housing part |
| 18 | connection side |
| 20 | connection |
| 22 | first longitudinal side |
| 24 | second longitudinal side |
| 26 | first end side |
| 28 | second end side |
| 30 | capacitive operating element |
| 32 | processor |
| 34 | line |
| 36 | output element |
| 38 | optical signal transmitter |
| 40 | light source |
| 42 | transparent area |
| 44 | capacitive release element |
| 46 | first capacitive area |
| 48 | second capacitive area |

1. A field device for an industrial plant, comprising at least one capacitive operating element by means of which an operating mode of the field device can be set, wherein the field device has a processor which is coupled to the at least one capacitive operating element, and wherein the processor is set up to implement an operation of the capacitive operating element only if a release based on an actuation pattern or an external release signal has been effected.

2. The field device according to claim 1, wherein the at least one capacitive operating element comprises two capacitive areas arranged on different sides of the field device.

3. The field device according to claim 1, wherein the at least one capacitive operating element comprises two capacitive areas arranged on opposite sides of the field device.

4. The field device according to claim 2, comprising a connection side, a first longitudinal side, a second longitudinal side, a first end side, and a second end side, wherein one of the two capacitive areas is arranged on the first longitudinal side of the field device and wherein the other of the two capacitive areas is arranged on the second longitudinal side of the field device.

5. The field device according to claim 2, wherein simultaneous contact of the two capacitive areas represents an actuation pattern, by means of which the release and operation occur simultaneously.

6. The field device according to claim 1, further comprising an output element for outputting a signal which specifies the actuation pattern to a user.

7. The field device according to claim 6, wherein the output element is an optical signal transmitter which is configured to output a light signal at a location where the capacitive operating element is arranged.

8. The field device according to claim 6, wherein the release is effected by operating the at least one capacitive operating element in accordance with the actuation pattern output by the output element.

9. The field device according to claim 1, wherein the capacitive operating element is configured to allow setting of the operating mode of the field device only within a specified period after the field device has been started up.

10. The field device according to claim 9, wherein the specified period is a maximum of 15 minutes.

11. The field device according to claim 9, wherein the specified period is a maximum of 1 minute.

12. The field device according to claim 9, wherein the specified period is a maximum of 10 seconds.

13. The field device according to claim 1, further comprising a capacitive release element which is configured to release the capacitive operating element.

14. A method of setting an operating mode of a field device having at least one capacitive operating element, comprising steps of:
detecting a release which is effected on a basis of an actuation pattern of the at least one capacitive operating element or an external release signal, and
implementing an operation of the capacitive operating element only if the release has been detected beforehand.

15. The method according to claim 14, wherein the actuation pattern is a simultaneous actuation of at least two capacitive areas of the at least one capacitive operating element or an actuation of the at least one capacitive operating element in a defined temporal sequence.
